(19) United States
(12) Patent Application Publication
(10) Pub. No.: US 2004/0258000 A1
(43) Pub. Date: Dec. 23, 2004

(54) Automatic mode selection in Annex C

(76) Inventors: Jalil Kamali, San Jose, CA (US); Guozhu Long, Fremont, CA (US); Sanjay Gupta, Union City, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 10/835,913

(22) Filed: Apr. 30, 2004

Related U.S. Application Data
(60) Provisional application No. 60/467,709, filed on May 2, 2003.

(51) Int. Cl. H04L 12/26

(52) U.S. Cl. 370/252; 370/332

(57) ABSTRACT

A system and method for selecting the operational mode in an ADSL Annex C environment during the handshake operation while increasing the accuracy of the determining the throughputs across the possible frequency spectrum while only having access to the power level of a small number of frequency bins during the handshake operation. In one embodiment of the present invention, the present invention receives signals in a multiple but small number of bins and estimates the loop length based upon the signal power in at least two of these bins. The present invention then identifies the noise profile over the relevant band of frequencies (or a subset thereof) to determine the bit rate. In one embodiment, the present invention selects the mode based upon a the bit rate in a single direction. In another embodiment, the present invention selects the mode based upon both the upstream and downstream bit rates.

### RELATED APPLICATIONS

This application claims priority from U.S. provisional application No. 60/467,709 filed on May 2, 2003 by Kamali et al., which is incorporated by reference herein in its entirety.

### FIELD OF THE INVENTION

The present invention relates to the field of digital subscriber loops (DSL) and more particularly to automatically selecting a mode for an asynchronous DSL (ADSL) based upon ITU-T Recommendation G.992.1 Annex C.

### BACKGROUND OF THE INVENTION

Due to the presence of the non-stationary time compression multiplex integrated services digital network (TCM-ISDN) services in Japanese telephone network, a specially designed version of ADSL that is defined by the International Telecommunications Union (ITU) Telecommunication Standardization Sector (ITU-T) Recommendation G.992.1 Annex C, which is incorporated by reference herein in its entirety, is deployed in Japan. Annex C originally had two operational modes: DBM (Dual bit map) and FBM (Far-end-cross-talk (FEXT) bit map). Recently, more operational modes have been added as a new amendment to Annex C. Based on this new standard, a modem should be able to support many different modes of operation. The new operation modes include G.992.1 Annex I which doubles to downstream band from 138-1104 kilo-hertz (kHz) to 138-2204 kHz, and FBM with shaped Overlap spectrum (FBMsOL) which uses 25-1104 kHz for downstream in FBM mode, as well as a few other modes. However, determining the optimum mode for a particular loop is a challenge. Service providers prefer that modems make the automatic selection based on some measurement. Since the mode of operation should be selected before the modem training and communicated in the initial handshake (based on ITU-T G.994.1, which is incorporated by reference herein in its entirety), it is desirable to select the optimal mode during the handshake. To make the selection, it is very useful to measure the loop configuration and channel noise conditions. A decent estimate of the loop configuration may be calculated based on the measurement of the channel transfer function or insertion loss in the entire frequency band. However, in the handshake, the modems transmit only a very limited number of tones. As a result, the insertion loss can only be measured at a few frequencies. This makes the loop configuration estimate difficult.

One conventional solution is to roughly select a mode in handshake, and get into modem training. During modern training, the total channel insertion loss is measured and exchanged through messages. Based on the insertion loss, the mode of operation is selected. The modem typically has to go back to handshake again and finalize the mode selection. However, there are at least two drawbacks for this method. First, selecting the mode based merely on the total insertion loss may not be optimum since the channel noise conditions are not taken into consideration. Secondly, the modem has to go through handshake and training twice, leading to longer initialization time.

Another other possible solution is to measure the signal level of the received handshake tones, and roughly estimate the loop length. Based on the rough estimate of the loop length, the mode is selected. There are at least two drawbacks for this method. First, selecting the mode based merely on loop length estimation may not be optimum since the channel noise conditions are not taken into consideration. Secondly, the loop length estimation based on the absolute received signal level at a few frequencies may not be very accurate.

What is needed is a system and method for selecting the mode in an ADSL Annex C environment during the handshake operation while increasing the accuracy of the determining the throughputs across the possible frequency spectrum while only having access to the power level of a small number of frequency bins during the handshake operation.

### SUMMARY OF THE INVENTION

The present invention is a system and method for selecting the mode in an ADSL Annex C environment during the handshake operation while increasing the accuracy of identifying the throughputs across the possible frequency spectrum while only having access to the power level of a small number of frequency bins during the handshake operation. In one embodiment of the present invention, the present invention receives signals in a multiple, but small, number of bins and estimates the loop length based upon the signal power in at least two of these bins. The present invention then identifies the noise profile over the relevant band of frequencies (or a subset thereof) to determine the bit rate. In one embodiment, the present invention selects the mode based upon a the bit rate in a single direction. In another embodiment, the present invention selects the mode based upon both the upstream and downstream estimated bit rates.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIG. 1 is a chart illustrating the loop length estimation according to one embodiment of the present invention and of the estimation error according to one embodiment of the present invention.

FIG. 2 are charts showing the estimated and real loop length for a 0.4 mm paper insulated loop for 1 kilometer (km), 2 km, 4 km and 6 km loops according to one embodiment of the present invention.

FIG. 3 are charts illustrating the bit rate for three modes in the no cross-talk environment and the ISDN environment according to one embodiment of the present invention.

FIG. 4 are charts illustrating the optimum and real bit rates for 0.4 mm loops in the no cross-talk environment and the same quad ISDN environment according to one embodiment of the present invention.

FIG. 5 is a flowchart of the method of operation of one embodiment of the present invention.

### DETAILED DESCRIPTION OF THE INVENTION

A preferred embodiment of the present invention is now described with reference to the figures where like reference numbers indicate identical or functionally similar elements. Also in the figures, the left most digits of each reference number corresponds to the figure in which the reference number is first used.

Reference in the specification to “one embodiment” or to “an embodiment” means that a particular feature, structure, or characteristic described in connection with the embodiments is included in at least one embodiment of the invention. The appearances of the phrase “in one embodiment” in various places in the specification are not necessarily all referring to the same embodiment.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by a variety of operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention as described herein, and any references below to specific languages are provided for disclosure of enablement and best mode of the present invention.

In addition, the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

In one embodiment of the present invention operates in an ADSL environment where Annex C applies such that the embodiment detects the received signal power in a small number of frequency bands (bins) along with noise measurements from the entire relevant frequency spectrum (or a portion thereof) and uses this information to select the optimal mode of operation.

One embodiment of the present invention solves the problem of selecting the optimal operational mode while only having limited line information. The information available in this embodiment includes the received signal power in a few bins, e.g., from handshake tones, as well as the noise measurements in TCM-ISDN near-end-cross-talk (NEXT) and far-end-cross-talk (FEXT) periods. TCM-ISDN uses time division duplex. The NEXT period occurs when there is only near end cross-talk from TCM-ISDN and the FEXT period occurs when there is only far end cross-talk from TCM-ISDN. Since the transmitted power is known, the present invention uses the above information to determine the loop insertion loss in the handshake bins. In the current handshake standard, ITU-T G.994.1, these handshake bins are bins 12, 14, 16, and 64.

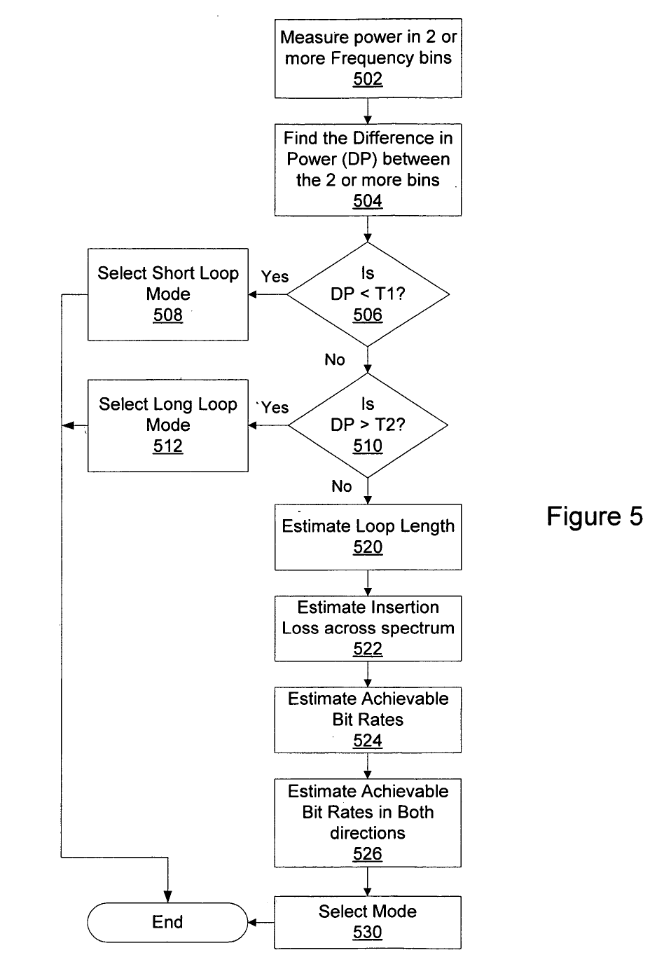

FIG. 5 is a flowchart of the method of operation of one embodiment of the present invention. In one embodiment of the present invention, the loop length is identified from the insertion loss when signals from only a few frequency bins are received, e.g., bins 12, 14, 16, and/or 64, for instance. The present invention measures 502 the power received in two or more of these bins. The measured power may not be reliable for use in absolute terms due to various gains and attenuation in the signal path, and the remote mode may transmit handshake tones at a different power level. Accordingly, one embodiment the present invention uses these values in a relative fashion by, for example, calculating the difference 504 in the insertion loss between at least two bins. Based on this insertion loss difference, the present invention can use a look-up table based to estimate the loop length from the measured power. If the power is measured in N bins, there will be N−1 relative numbers which can be used and thus the look up table will have N−1 inputs for loop length estimation. In the case of the current handshake standard G.994.1, however, the insertion loss for bins 12, 14, and 16 are generally close (within the measurement error) and thus these three bins only produce one independent number. Therefore in this case, only one relative data is accessible and the resulting look up table will be one dimensional. In alternate embodiments more bins can be used and multivariable interpolation can be used to estimate the loop length.

In one embodiment of the present invention the operational mode can be selected based solely on the calculated difference in power between the two or more bins. In this embodiment, if the difference in power is less than a first threshold (T1) 506, then the present invention determines that the loop is short and a short loop mode is selected 508. If the difference in power is greater than a second threshold (T2) 510, then the present invention determines that the loop is long and a long loop mode is selected 512. In some embodiments of the present invention, steps 506, 508, 510 and 512 are not performed.

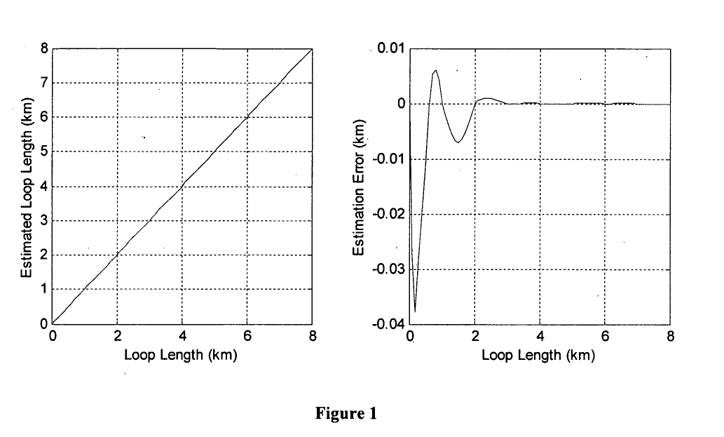

In one embodiment, the present invention generates a look-up table relating the difference between the insertion losses of bin 12 (or 14 or 16) and bin 64, to the loop length. This look-up table is used to estimate the loop length. One example of such a lookup table is set forth below in Table 1. In one embodiment, a look up table with 9 rows (loop length at 0, 1, 2, . . . , 8 km) is used for loop length estimation in the range of 0 to 8 km which is currently the entire range of loop length in Japan. For the intermediate values, interpolation can be used to achieve greater accuracy. For example, in one embodiment linear interpolation between the table values is used while in alternate embodiments of higher order interpolation (or alternative techniques such as Spline method) is used. FIG. 1 shows the estimated loop length (using the above method) versus the real loop length 0.4 mm paper insulated loops (Japanese loops). As FIG. 1 demonstrates, the estimation error of the present invention is small and, therefore the estimated loop length is accurate. It is envisioned that other table sizes and interpolation techniques can be used without departing from the scope of the present invention.

TABLE 1

| | Difference of the |
|---|---|
| Loop Length | measured power in bins |
| (km) | 12 and 64 (dB) |
| 0 | 0.00 |
| 1 | 6.60 |
| 2 | 12.87 |
| 3 | 19.21 |
| 4 | 25.55 |
| 5 | 31.90 |
| 6 | 38.24 |
| 7 | 46.59 |
| 8 | 53.21 |

After estimating 520 the loop length, the present invention estimates 522 the insertion loss in substantially all the frequency bins. To accurately calculate the insertion loss in the bins conventional systems have used complicated formulas that require significant computing cost. To simplify the implementation while ensuring sufficient accuracy, the present invention uses a piece-wise linear formula which generates an estimate of the channel insertion loss across the entire spectrum. Equation (1) generates an estimate for the insertion loss (Hₗ(f) in dB) in terms of the loop length (1 in Km) and frequency (f in KHz) for 0.4 mm paper insulated cable.

$${H}_{l} ( f ) = \{ \begin{matrix}- 0.0257 lf - 8.4332 l & f < 800 KHz \\ - 0.0169 lf - 15.3057 l & f > 800 KHz\end{matrix} \qquad ( 1 )$$

Similar formulas can be identified for other cable types (polyethylene insulated or paper insulated with different diameters 0.32 mm, 0.4 mm, 0.5 mm, etc.).

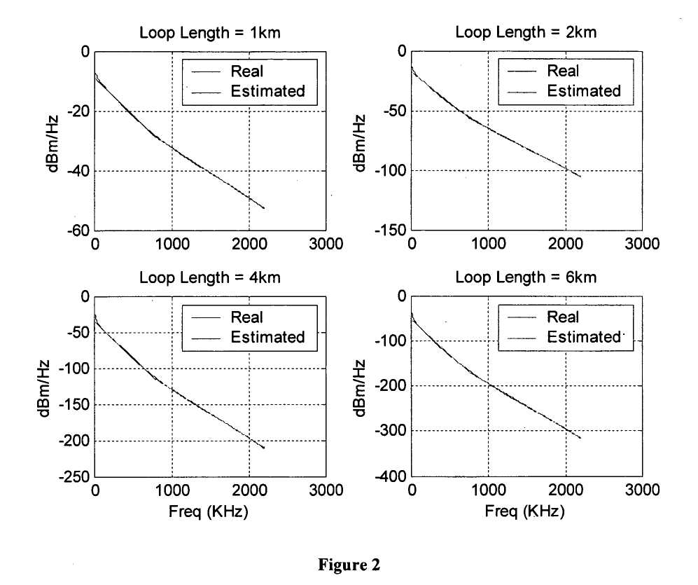

FIG. 2 shows the estimated channel insertion loss, using equation (1), as compared with the real insertion loss for different loop lengths. As FIG. 2 shows, the present invention accurately estimates the insertion loss for all of these loop lengths.

Using the estimated loop length and the measured noise profiles, the present invention estimates 524 the achievable bit rate for each of the possible operational modes and for both noise maps from the well-known formula set forth as equation (2). Other possible operational modes may be set forth in a standard. Currently, the operational modes defined in Annex C include those defined in ITU-T Standard G.992.1 Annex-C and its amendment of January 2003. The present invention will also work with different modes that may or may not be set forth in a standard.

$$b = R {\sum }_{i = {bin}_{min}}^{{bin}_{max}} {log}_{2} ( 1 + \frac{{S}_{i}}{Γ {N}_{i}} ) \qquad ( 2 )$$

where R=4 kilo-symbol/second is the symbol rate and b in Kbps is the bit rate. Sᵢ and Nᵢ are the signal and noise powers in bin i, respectively and Γ is called SNR Gap (9.75 dB in Japanese Standard). The overall bit rate is then found from the Map A (FEXT bit map where TCM-ISDN creates only FEXT) and Map B (NEXT bit map where TCM-ISDN creates NEXT) bit rates as follows.

$${b}_{tot} = 32 [ \frac{0.37 {b}_{A} + 0.63 {b}_{B}}{32} ] \qquad ( 3 )$$

where the value within the brackets [α]denotes the nearest integer to x (this operation is optional). Once the bit rate of each system is found, the present invention selects 530 the optimum operational mode, e.g., the mode with the maximum bit rate.

The above technique can also account for the data rate in both directions (upstream and downstream) when determining the optimal operational mode. In this embodiment the present invention estimates 526 the achievable bit rates in both directions using, for example, the above technique for each direction. The calculated capacities can be sent back to the transmitter. For instance, if the Central Office (CO) receives the downstream capacities (calculated in CPE), then using similar signal (or the loop length estimate by the remote modem) and noise measurements in the upstream direction, it can calculate the upstream capacities, and the present invention can select 530 the operational mode having the optimum combined upstream and downstream performance. The objective function to be maximized may be a weighted sum of upstream and downstream rates if one of them is more important to the user, for example.

In one embodiment of the present invention, a system consisting of three possible operation modes, described below, are considered. In this example, only the downstream performance is used as a factor in determining the optimal operational mode. The three possible operational modes in this example are (1) Double spectrum; (2) Double Bit Map (DBM) with Trellis coding; and (3) FEXT Bit Map (FBM) with shaped Overlap spectrum (FBMsOL).

As described above, the present invention can be extended to mode selection among more modes of operations, such as system using even wider spectrum than double spectrum, or selecting different PSD's (transmit different power spectrum densities) to optimize the performance. The invention can also be used in non-TCM-ISDN environment where there is only one bit map.

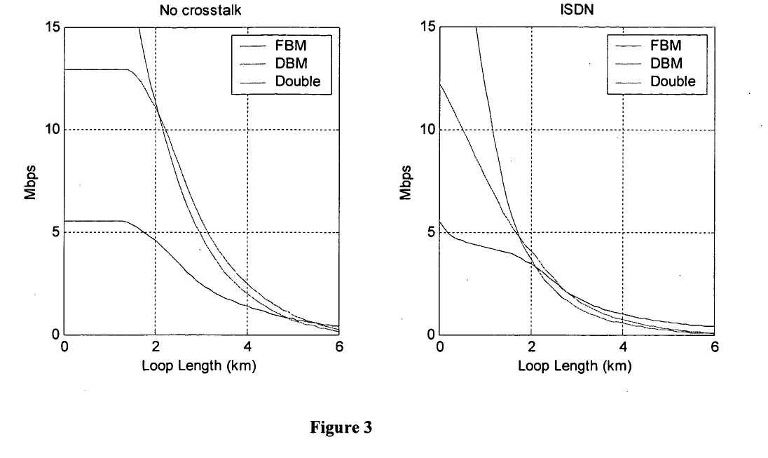

Using a typical choice of parameters, the capacity of these three modes versus loop length for 0.4 mm paper insulated loops is calculated and shown in FIG. 3 for the case of no cross-talk and ISDN cross-talk. As is seen in FIG. 3, the switch-over takes place at approximately 2 km and 5.5 km when there is no cross-talk and at approximately 1.9 km and 2.8 km in the presence of ISDN noise.

According to one embodiment of the present invention, the present invention estimates the loop length by linearly interpolating Table 1, identifies the loop insertion loss at the estimated loop length at all the bins using equation (1) and finds the channel capacity in maps A and B using the given noise profiles. Based upon this information the present invention selects the optimum system for all plain 0.4 mm loops.

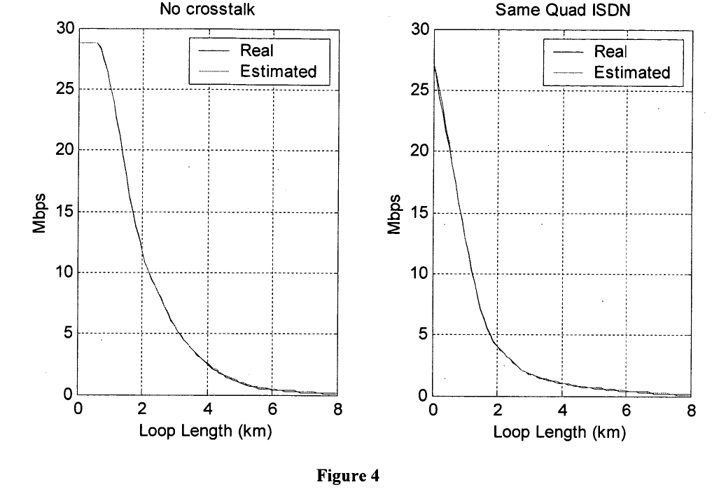

FIG. 4 shows the optimum channel capacity (estimated vs. real) which illustrates that in all loop lengths the method of the present invention correctly selects the optimum system.

While particular embodiments and applications of the present invention have been illustrated and described herein, it is to be understood that the invention is not limited to the precise construction and components disclosed herein and that various modifications, changes, and variations may be made in the arrangement, operation, and details of the methods and apparatuses of the present invention without departing from the spirit and scope of the invention as it is defined in the appended claims.

What is claimed is:

1. A method for estimating a loop length in an asymmetric digital subscriber line (ADSL) environment comprising the steps of:
measuring power in two or more frequency bands in a first frequency spectrum during a first handshake operation;
determining a difference in power between said two or more frequency bands; and
estimating the loop length in an ADSL environment based upon said difference in power.

2. The method of claim 1, further comprising the step of:
estimating a channel insertion loss across said first frequency spectrum using a piece-wise linear formula.

3. The method of claim 2, wherein said first frequency spectrum corresponds to substantially the whole transmission frequency spectrum in the ADSL environment.

4. The method of claim 2, wherein said first frequency spectrum corresponds to the whole transmission frequency spectrum in the ADSL environment.

5. The method of claim 2, further comprising the steps of:
measuring a first noise profile in a first period for two or more operational modes;
measuring a second noise profile in a second period for two or more operational modes;
estimating a first bit rate corresponding to a data transfer rate across a first direction in a first transmission path using said first and second noise profiles and said channel insertion loss for each of said operational modes.

6. The method of claim 5, wherein said first period is a far-end-cross-talk period.

7. The method of claim 6, wherein said second period is a near-end-cross-talk period.

8. The method of claim 5, further comprising the steps of:
receiving a second bit rate corresponding to an estimate of a data transfer rate across a second direction in said first transmission path; and
selecting a preferred operational mode based upon said first and second bit rates.

9. The method of claim 5, further comprising the steps of:
receiving a second bit rate corresponding to an estimate of a data transfer rate across a second direction in said first transmission path; and
selecting a preferred operational mode based upon said second bit rate.

10. The method of claim 5, further comprising the step of:
selecting a preferred operational mode based upon said first bit rate.

11. The method of claim 2, further comprising the steps of:
measuring a noise profile for two or more operational modes;
estimating a first bit rate corresponding to a data transfer rate across a first direction in a first transmission path using said noise profile and said channel insertion loss for each of said operational modes.

12. The method of claim 11, further comprising the steps of:
receiving a second bit rate corresponding to an estimate of a data transfer rate across a second direction in said first transmission path; and
selecting a preferred operational mode based upon said first and second bit rates.

13. The method of claim 11, further comprising the step of:
selecting a preferred operational mode based upon said first bit rate.

14. The method of claim 11, further comprising the step of:
receiving a second bit rate corresponding to an estimate of a data transfer rate across a second direction in said first transmission path; and
selecting a preferred operational mode based upon said second bit rates.

15. The method of claim 1, wherein said step of measuring power occurs in less than five frequency bands in said first frequency spectrum.

16. The method of claim 1, wherein said step of measuring power occurs in less than ten frequency bands in said first frequency spectrum.

17. The method of claim 1, wherein said step of measuring power occurs in less than twenty frequency bands in said first frequency spectrum.

18. A system for estimating a loop length in an asymmetric digital subscriber line (ADSL) environment comprising:
first means for measuring power in two or more frequency bands in a first frequency spectrum during a first handshake operation;
second means for determining a difference in power between said two or more frequency bands; and
third means for estimating the loop length in an ADSL environment based upon said difference in power.

19. The system of claim 18, further comprising:
fourth means for estimating a channel insertion loss across said first frequency spectrum using a piece-wise linear formula.

20. The system of claim 19, wherein said first frequency spectrum corresponds to substantially the whole transmission frequency spectrum in the ADSL environment.

21. The system of claim 19, wherein said first frequency spectrum corresponds to the whole transmission frequency spectrum in the ADSL environment.

22. The system of claim 19, further comprising:
fifth means for measuring a first noise profile in a first period for two or more operational modes;
sixth means for measuring a second noise profile in a second period for two or more operational modes;
seventh means for estimating a first bit rate corresponding to a data transfer rate across a first direction in a first transmission path using said first and second noise profiles and said channel insertion loss for each of said operational modes.

23. The system of claim 22, wherein said first period is a far-end-cross-talk period.

24. The system of claim 23, wherein said second period is a near-end-cross-talk period.

25. The system of claim 22, further comprising:
eighth means for receiving a second bit rate corresponding to an estimate of a data transfer rate across a second direction in said first transmission path; and
ninth means for selecting a preferred operational mode based upon said first and second bit rates.

26 The system of claim 22, further comprising:
eighth means for receiving a second bit rate corresponding to an estimate of a data transfer rate across a second direction in said first transmission path; and
ninth means for selecting a preferred operational mode based upon said second bit rate.

27. The system of claim 22, further comprising:
eighth means for selecting a preferred operational mode based upon said first bit rate.

28. The system of claim 19, further comprising:
fifth means for measuring a noise profile for two or more operational modes; and
sixth means for estimating a first bit rate corresponding to a data transfer rate across a first direction in a first transmission path using said noise profile and said channel insertion loss for each of said operational modes.

29. The system of claim 28, further comprising:
seventh means for receiving a second bit rate corresponding to an estimate of a data transfer rate across a second direction in said first transmission path; and
eighth means for selecting a preferred operational mode based upon said first and second bit rates.

30. The system of claim 28, further comprising:
seventh means for selecting a preferred operational mode based upon said first bit rate.

31. The system of claim 28, further comprising:
seventh means for receiving a second bit rate corresponding to an estimate of a data transfer rate across a second direction in said first transmission path; and
eighth means for selecting a preferred operational mode based upon said second bit rates.

32. The system of claim 18, wherein said step of measuring power occurs in less than five frequency bands in said first frequency spectrum.

33. The system of claim 18, wherein said step of measuring power occurs in less than ten frequency bands in said first frequency spectrum.

34. The system of claim 18, wherein said step of measuring power occurs in less than twenty frequency bands in said first frequency spectrum.
